(19) United States
(12) Patent Application Publication
(10) Pub. No.: US 2006/0116116 A1
(43) Pub. Date: Jun. 1, 2006

(54) Methods, systems, and computer program products for providing time based, programmable ringer controls

(76) Inventors: John Slemmer, Norcross, GA (US); Emily Colvin, Knoxville, TN (US)

Correspondence Address: CANTOR COLBURN LLP - BELLSOUTH, 55 GRIFFIN ROAD SOUTH, BLOOMFIELD, CT, 06002, US

(21) Appl. No.: 11/000,144

(22) Filed: Nov. 30, 2004

(51) Int. Cl. H04M 3/00

(52) U.S. Cl. 455/418

(57) ABSTRACT

A method, system, and computer program product for providing time-based, programmable ringer controls for a communications device. The method includes associating a ring type with a time-based event, and associating a volume setting with the ring type and the time-based event.

### BACKGROUND OF THE INVENTION

Exemplary embodiments of the invention relate generally to telecommunications services and, more particularly, to methods, systems, and computer program products for providing time-based programmable ringer controls for communications devices.

Communications devices such as cellular telephones have become ubiquitous in every day life. The increasing usage of these devices have contributed to new societal problems in that many find them to be, at times, invasive or disruptive. For example, an outdoor soccer stadium would likely be able to absorb the sound of a ringer (as well as an ensuing conversation) much more readily than would an indoor dining establishment. Another problem caused by these devices is the disruption caused by the ringer sound during certain situations such as a concert hall event, library, or religious service. Thus, the sound of a device's ringer (and associated usage) may be acceptable in some situations but offensive, inappropriate, or harmful in others. Sound emissions (e.g., ringers) currently allow many choices of ring, tone, and volume, but do not provide for time or situation-based controls. In other words, once set, the communications device will ring the same way at any time of the day and week. The ring, tone, and/or volume desired or appropriate may change from one time period to the next time period (e.g., a softer tone for night time).

What is needed therefore, is a way to provide time-based, programmable ringer functionality to communications devices.

### SUMMARY OF THE INVENTION

Exemplary embodiments relate to methods, systems, and computer program products for providing time-based programmable ringer controls for communications devices. Methods include associating a ring type with a time-based event, and associating a volume setting with the ring type and the time-based event.

Systems for providing time-based programmable ringer controls for communications devices include a ringer control application executing on at least one of the communications device and a host system. The ringer control application associates a ring type with a time-based event, and associates a volume setting with the ring type and the time-based event.

Computer program products for providing time-based programmable ringer controls for communications devices include instructions for performing a method. The method includes associating a ring type with a time-based event, and associating a volume setting with the ring type and the time-based event.

Other systems, methods, and/or computer program products according to exemplary embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Referring now to the drawings wherein like elements are numbered alike in the several FIGURES:

FIG. 1 is a block diagram of a system upon which the programmable ringer control functions may be implemented in exemplary embodiments;

FIG. 2 is a flow diagram of a process for implementing programmable ringer control functions in exemplary embodiments; and

FIG. 3 is a user interface screen depicting user-selected settings in exemplary embodiments.

### DETAILED DESCRIPTION OF EXEMPLARY EMBODIMENTS

In accordance with exemplary embodiments, time-based programmable ringer controls are provided. The programmable ringer control system enables user-configurable ringer, tone, and volume settings by day of week, time of day, as well as other time-based or situation-based events (e.g., holidays, sleeping hours, etc.). Additionally, the programmable ringer control system may also provide for automatic settings or profile adjustments (e.g., on Christmas day each year change ringer tone to holiday music).

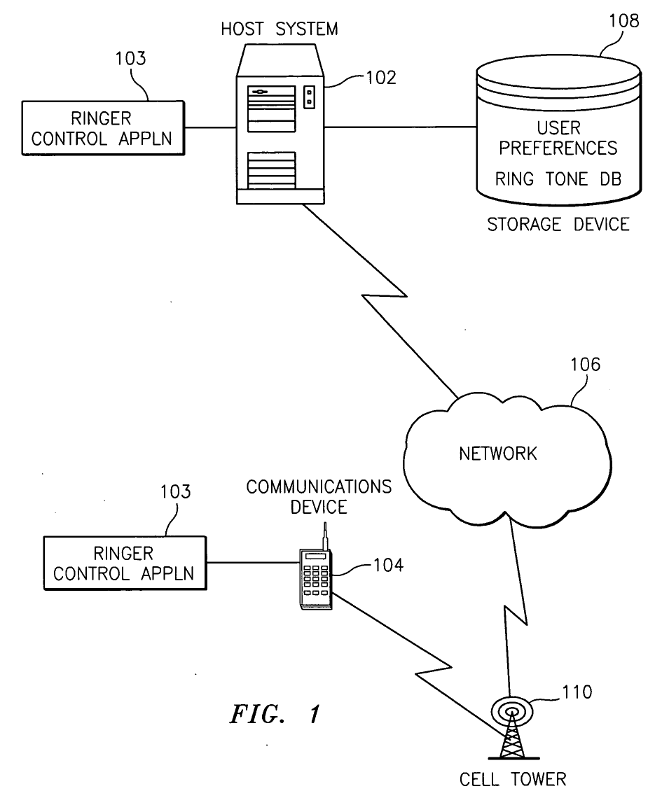

Turning now to FIG. 1, a system upon which the programmable ringer control functions may be implemented in exemplary embodiments will now be described. In accordance with exemplary embodiments, the system of FIG. 1 includes a host system 102 and communications device 104 in communication via a network 106. Also included in the exemplary system of FIG. 1 is a cell tower 110.

In exemplary embodiments, host system 102 may be a communications services provider that provides carrier services to its customers (e.g., a user of wireless communications device 104). The host system 102 depicted in FIG. 1 may be implemented using one or more servers operating in response to a computer program stored in a storage medium accessible by the server. The host system 102 may operate as a network server (e.g., a web server) to communicate with the communications device 104. The host system 102 may handle sending and receiving information to and from the communications device 104 and may perform associated tasks.

Alternatively, host system 102 may be a third-party service provider entity (e.g., an application service provider (ASP) that provides programmable ringer control services to customers (e.g., carrier systems) for a fee.

The host system 102 may also operate as an application server. The host system 102 executes one or more computer programs to provide programmable ringer control functions. These one or more computer programs are referred to collectively herein as a programmable ringer control application 103. Processing of ringer control activities may be shared by the host system 102 and the communications device 104 by providing an application (e.g., java applet) to the communications device 104. Alternatively, a stand-alone software application operating on the communications device 104 may perform a portion or all of the processing described herein. As previously described, it is understood that separate servers may be utilized to implement the network server finctions and the application server finctions. Alternatively, the network server and the application server may be implemented by a single server executing computer programs to perform the requisite functions.

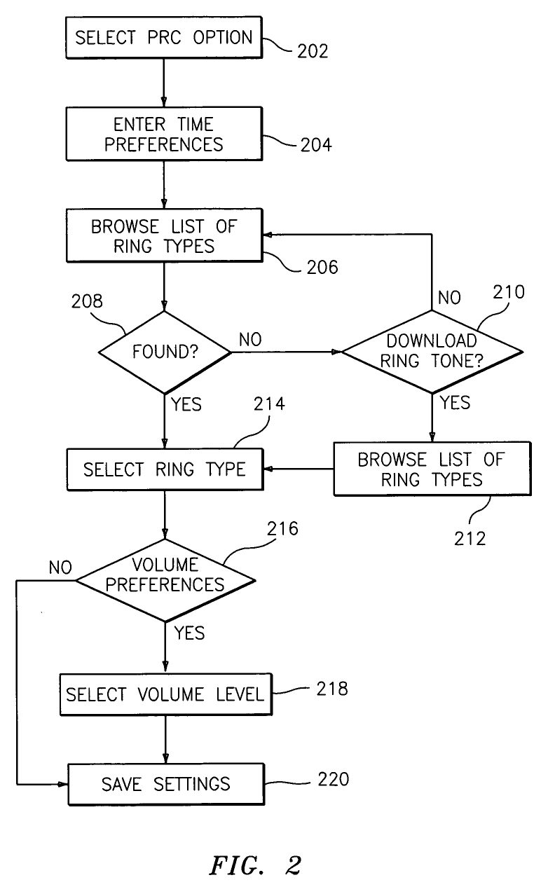

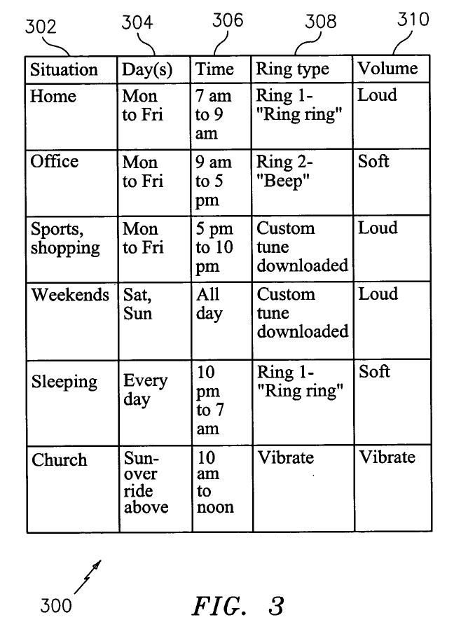

In exemplary embodiments, the system shown in FIG. 1 includes a storage device 108. Storage device 108 is in communication with host system 102 and may be implemented using a variety of devices for storing electronic information. It is understood that the storage device 104 may be implemented using memory contained in the host system 102 or it may be a separate physical device. The storage device 108 is logically addressable as a consolidated data source across a distributed environment that includes network 106. Information stored in the storage device 108 may be retrieved and manipulated via the host system 102. The storage device 108 houses one or more databases of customer ringer control preferences and may also store ring tones for selection and download as described in the flow diagram of FIG. 2. For example, ring tones may include a standard phone ring, a beeping tone, a musical tone, or a vibrating tone. A user interface depicting sample user preference settings is shown in FIG. 3. In an exemplary embodiment, the host system 102 operates as a database server and coordinates access to application data including data stored on storage device 108.

Network 106 may be any type of known network including, but not limited to, a wide area network (WAN), a local area network (LAN), a global network (e.g. Internet), a virtual private network (VPN), and an intranet. The network 106 may be implemented using a wireless network or any kind of physical network implementation known in the art. Communication device 104 may be coupled to the host system 102 through multiple networks (e.g., intranet and Internet).

Cell tower 110 refers to a cellular network element that receives and transmits wireless communications between communications devices within a cell location or between a wireless communication device (e.g., wireless communication device 104) and a carrier system or central office (e.g., host system 102 where host system 102 is a carrier). Wireless communication device 104 refers to a mobile communications device that communicates with other communication devices over a network. Wireless communications device 104 may be, for example, a pager, a cellular telephone, a personal digital assistant, or any similar type of network-enabled handheld device that produces a noise. For purposes of illustration, the wireless communications device 104 will be described herein with respect to a cell phone.

Turning now to FIG. 2, a flow diagram of a process for implementing the programmable ringer control finctions will now be described exemplary embodiments. As indicated above, the programmable ringer control application 103 may reside on the communications device 104 or may be accessed by the communications device via the host system 102. If the programmable ringer control application 103 is executing on the host system 102, the user may access the application 103 via, e.g., a website provided by the host system 102 over network 106. Alternatively, the communications device 104 may access the host system 102 via cell tower 110, which in turn, accesses the host system 102 over network 106.

The communications device 104 user selects the programmable ringer control option from e.g., the website of host system 102 or, alternatively, if the application 103 is executing on the communications device 104, via the menu options provided on the interface screen of the device 104 at step 202. The user is then prompted to select time preferences at step 204. The time preferences may be selected time of day ranges, day of week ranges, season of year ranges, or situational-based times. Sample time-based preference selections are shown generally in the user interface screen 300 of FIG. 3 in columns 302-306. Situational-based times may include holidays, sleeping schedules, recreational events, work events, personal events, etc.

For each time period selected, the user is prompted to select a ring type (also referred to as ring tone) from a list of available ring tones presented at step 206. These ring tones are typically provided to customers free of charge or included in the service plan associated with a customer. These ring tones are also typically resident on the communications device 104. At step 208, it is determined whether the user has successfully selected a ring tone from the list. If not, the user is prompted to access an alternative source of ring tones at step 210 that may be downloaded to the communications device. This alternative source of ring tones may be outside of the service plan and may also be provided to customers for a fee.

If the user does not wish to download a ring tone from the alternative source, the user may be redirected to the original list of ring tones at step 206. Otherwise, the user is presented with a listing of alternative ring tones for selection and download at step 212. At step 214, the user selects a ring tone from the alternative list, which is then downloaded to the communications device 104. Sample ring tone selections are shown generally in the user interface screen 300 of FIG. 3 in column 308. Examples of ring types may be a standard ring, a beeping tone, a music tune, a vibrate mode, etc.

At step 216, it is determined whether the user desires to associate a volume setting with the ring tone selected for the time period. If not, the selections are saved and ready for implementation at step 220. If the user desires to associate a volume level with the ring tone for the time period, the user may select from options such as loud, moderate, and soft. If the ring tone selected is vibrate mode, then the volume setting may be defaulted to vibrate whereby no further setting is required. Sample volume settings are shown in the user interface screen 300 of FIG. 3 in column 310. Once the user has finished selecting volume settings for each of the ring tones associated with each time period, the settings are saved to the user preferences and are stored, e.g., in storage device 108 and/or communications device 104.

As indicated above, the programmable ringer control system enables user-configurable ringer, tone, and volume settings by day of week, time of day, as well as other time-based or situation-based events (e.g., holidays, sleeping hours, etc.). Additionally, the programmable ringer control system may also provide for automatic settings or profile adjustments.

As described above, embodiments may be in the form of computer-implemented processes and apparatuses for practicing those processes. In exemplary embodiments, the invention is embodied in computer program code executed by one or more network elements. Embodiments include computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims.

What is claimed is:

1. A method for providing time-based, programmable ringer controls for a communications device, comprising:
associating a ring type with a time-based event; and
associating a volume setting with the ring type and the time-based event.

2. The method of claim 1, wherein the time-based event is selected from at least one of:
a time of day range;
a day of week range;
a season of year range; and
a situational event.

3. The method of claim 1, wherein the associating a ring type includes downloading the ring type over a network.

4. The method of claim 1, wherein the associating a ring type includes selecting the ring type from a list of ring types resident on the communications device.

5. The method of claim 1, wherein the ring type includes at least one of:
a standard ring;
a beeping tone;
a musical tone; and
a vibrate mode.

6. The method of claim 1, wherein the associating a volume setting with the ring type includes associating at least one of:
a default volume level;
a soft volume level;
a moderate volume level;
a loud volume level; and
a vibrate mode.

7. The method of claim 1 wherein the associating a ring type to a time-based event is performed in response to a user request via the communications device.

8. The method of claim 1, wherein the situational event includes at least one of:
a holiday;
a sleep schedule;
a recreational event;
a work event; and
a personal event.

9. A system for providing time-based programmable ringer controls for a communications device, comprising:
a ringer control application executing on at least one of the communications device and a host system, the ringer control application performing:
associating a ring type with a time-based event; and
associating a volume setting with the ring type and the time-based event.

10. The system of claim 9, wherein the time-based event is selected from at least one of:
a time of day range;
a day of week range;
a season of year range; and
a situational event.

11. The system of claim 9, wherein the associating a ring type includes downloading the ring type from the host system to the communications device over a network.

12. The system of claim 9, wherein the associating a ring type includes selecting the ring type from a list of ring types resident on the communications device.

13. The system of claim 9, wherein the ring type includes at least one of:
a standard ring;
a beeping tone;
a musical tone; and
a vibrate mode.

14. The system of claim 9, wherein the associating a volume setting with the ring type includes associating at least one of:
a default volume level;
a soft volume level;
a moderate volume level;
a loud volume level; and
a vibrate mode.

15. The system of claim 9, wherein the associating a ring type to a time-based event is performed in response to a user request via the communications device.

16. The system of claim 9, wherein the situational event includes at least one of:
a holiday;
a sleep schedule;
a recreational event;
a work event; and
a personal event.

17. A computer program product for providing time-based, programmable ringer controls for a communications device, the computer program product including instructions for performing:
associating a ring type with a time-based event; and
associating a volume setting with the ring type and the time-based event.

18. The storage medium of claim 17, wherein the time-based event is selected from at least one of:
a time of day range;
a day of week range;
a season of year range; and
a situational event.

19. The computer program product of claim 17, wherein the associating a ring type includes downloading the ring type over a network.

20. The computer program product of claim 17, wherein the associating a ring type includes selecting the ring type from a list of ring types resident on the communications device.
